(19) United States
(12) Patent Application Publication
(10) Pub. No.: US 2007/0174255 A1
(43) Pub. Date: Jul. 26, 2007

(54) ANALYZING CONTENT TO DETERMINE CONTEXT AND SERVING RELEVANT CONTENT BASED ON THE CONTEXT

(75) Inventors: Ajay Sravanapudi, Reston, VA (US); Michael Brandon Sutler, Reston, VA (US); Sachin Devand, Ashburn, VA (US)

Correspondence Address: FISH & RICHARDSON P.C., P.O. BOX 1022, MINNEAPOLIS, MN, 55440-1022, US

(73) Assignee: Entrieva, Inc., Reston, VA (US)

(21) Appl. No.: 11/614,743

(22) Filed: Dec. 21, 2006

Related U.S. Application Data
(60) Provisional application No. 60/752,594, filed on Dec. 22, 2005.

(51) Int. Cl. G06F 17/30

(52) U.S. Cl. 707/3

(57) ABSTRACT

According to one general aspect, a method for supplementing input content with related content includes receiving the input content and identifying concepts from the input content. The method also includes identifying a taxonomy associated with the concepts, and analyzing the concepts using the taxonomy to generate a set of categorized concepts. The method also includes submitting the categorized concepts to a database to identify the related content and to supplement the input content with the related content.

### CROSS REFERENCE TO RELATED APPLICATIONS

The present application claims priority from U.S. Provisional Application Ser. No. 60/752,594, filed Dec. 22, 2005. The contents of the prior application are incorporated herein by reference in their entirety.

### TECHNICAL FIELD

This document relates to analyzing content to determine context and identifying advertisements or other relevant or valuable content to be served based on the context, and further relates to a semantic content router for managing multiple domains of knowledge.

### BACKGROUND

As a result of the growth of electronic content available on the internet and the variety of methods being used for serving advertisements and other content to internet users, there continues to be a fundamental difficulty with providing internet users with relevant or related advertisements and relevant or related content based on information which they are searching for or reading on-line.

Taxonomies can be used to classify or categorize internet based electronic content so that contextual relevancy can be established. Typically, taxonomies for categorizing pieces of electronic content focus on a single domain. However, electronic content representing multiple diverse domains may need to be categorized. A single taxonomy may be developed to include categorization rules for all of the domains. However, categorizing content using the large number of rules required by all of the domains may be prohibitively slow. In addition, categorization rules for one domain in the single taxonomy may conflict or interfere with categorization rules for another domain in the single taxonomy. Alternatively, multiple domain-specific taxonomies may be developed to avoid conflicting categorization rules. However, using each of the multiple taxonomies to categorize the content also may be prohibitively slow.

### SUMMARY

A context analysis engine identifies contextually valuable relevant and or related content (referred to throughout this disclosure as “relevant content”) that may be included in published electronic content. Typically, this relevant content is identified manually by editors who either mark the base content with a meaningful tag to be used by a separate software system or manually select the relevant content to embed in the base content. The context analysis engine automates this process by identifying key semantic concepts within the electronic base content and then matching them to relevant, high-value data or other relevant content. This data is then embedded in the content as the publisher sees fit. For example, the context analysis engine may identify semantically relevant content as a cost per click (CPC) advertisement, a cost per thousand (CPM) banner, syndicated content, or other valuable forms of navigation with the content. The content may include a web page, an article identified by an RSS feed, key words used to form a search query, search results for a search query, or any other electronic content that may be converted to plain text.

Lexical semantic analysis (LSA) may be used to identify concepts included in a piece of electronic content. A large set of documents may be separated into multiple clusters based on characteristics of the documents, such as words included in the documents. Concepts may be extracted from each of the documents in a cluster, and the concepts that appear most frequently within the cluster, or are otherwise deemed important to the cluster, may be identified as concepts for the cluster. When concepts are to be extracted from a document, a cluster to which the document corresponds is identified. Concepts that have been previously identified for the identified cluster are identified as the concepts of the document.

A semantic content router that executes a semantic weighting process may be used to more efficiently categorize the concepts extracted from a document. The semantic content router (or simply, “router”) may identify a subset of multiple available taxonomies that may appropriately categorize a concept and then route the concept to the appropriate taxonomies.

The semantic weighting process analyzes the concepts to quickly ascertain the domain to which a concept or a set of words likely belongs. The information resulting from this analysis is used by one or more of the multiple taxonomies to efficiently categorize the concepts. The router is trained using a set of concepts that are tagged with indications of which of the multiple taxonomies should be used to categorize the concepts. Weights of a concept are identified for each of the multiple taxonomies, and the concept is categorized using taxonomies for which an identified weight exceeds a threshold value.

This context analysis engine can be used to implement valuable monetization and navigation functions on web sites. One example of an application of this type of navigation is “Sponsored Navigation.” The process works as follows. Using various software modules forming the context analysis engine, an entire publisher's web site is crawled, and all concepts on all pages are extracted and indexed using one or more taxonomies. Concepts that appear on each page of the website and related contents (based on taxonomies) associated with the concepts are hyperlinked. These “hyperlinks” are displayed in the form of an advertising unit which can be sponsored by an advertiser (e.g. “Sponsored Navigation”). Clicking on any of these hyperlinks within the ad unit could “trigger” multiple ad delivery options, such as a “transition ad”, an “in-line” text ad or a graphical ad about the topic. After transitioning, the user can explore the ad or be taken to the section of the web site where the additional “content” about the concept is presented.

Another example of a monetization application that may be implemented using the context analysis engine is a “ClickSense (™)” application. This is an application that can analyze a search query, URL (e.g. Webpage), RSS feed, blog, or any block of text, and using the semantic content router and available advertising inventory, the application can locate advertisements that are highly relevant or highly related to the search query, URL, RSS feed or block of text, and of a high value, and serve these advertisements onto the page the internet user has requested.

According to one general aspect, a method for supplementing an input content with related content includes receiving an input content for which a related content is to be identified, extracting text associated with the input content, and identifying concepts within the extracted. The method also includes identifying at least one taxonomy associated with the concepts and analyzing the concepts using the at least one taxonomy to generate a set of categorized concepts associated with one or more categories of the at least one taxonomy.

The method also includes submitting the categorized concepts to a database. The database stores data that are indexed based on their categories. The method also includes requesting, from the database, the related content associated with the categorized concepts, receiving, from the database, the related content in response to the request, supplementing the input content with the related content and enabling a user to view the related content.

Implementations of the above general aspect may include one or more of the following features. For example, the input content may include a search query for which search results are to be retrieved and extracting the text associated with the input content may include extracting keywords comprising the search query. Alternatively or additionally, extracting the text associated with the input content further may include accessing the search results and extracting the text from the accessed search results.

In another implementation, receiving the input content may include receiving a uniform resource locator, and extracting the text associated with the input content may include accessing a web page located at the uniform resource locator, and extracting text associated with the web page. Alternatively or additionally, receiving the input content may include receiving an RSS feed and extracting the text associated with the input content may include extracting the text included in the RSS feed. Alternatively or additionally, receiving the input content may include receiving an entry within a Blog and extracting the text associated with the input content may include extracting the entry within the Blog.

The related content may include an advertisement or sponsored link corresponding to one or more cost-per-click, cost-per-impression, or cost-per-action terms that are relevant or related to the input content. Identifying the concepts within the extracted text may include identifying one of noun phrases or proper nouns included in the text. Receiving the related content may further include identifying a category of the categorized concept and identifying, as the related content, content that appear within the database and that are associated with the identified category.

According to another general aspect, a method for supplementing a document with a user interface that includes a related content associated with one or more concepts appearing within the document includes extracting concepts appearing within a document stored within a memory, and identifying a taxonomy associated with the extracted concepts. The method also includes analyzing the extracted concepts using the taxonomy to generate a set of categorized concepts, and using the taxonomy or another related taxonomy to identify, within a plurality of other documents stored within the same or a different memory, related contents associated with the categorized concepts. The method also includes hyper-linking the extracted concepts and related contents and displaying the hyperlinked concepts and related contents within a user interface, wherein the user interface is sponsored by a content provider.

Implementations of the above general aspect may include one or more of the following features. For example, extracting concepts may include extracting text associated with the document and extracting one of noun phrases or proper nouns included in the text. The proper nouns may include names of people, entities, companies, or products. Alternatively or additionally, extracting concepts may include extracting concepts appearing within a web page of a web site.

Implementations of the above general aspects also may include receiving an indication of a selection of a hyperlink from among the displayed hyperlinks and in response to the received indication, displaying a web page associated with the selected hyperlink, wherein the web page includes additional contents related to the extracted concepts. The sponsored content provider may be the same entity as the publisher. Alternatively or additionally, the sponsored content provider is an entity different from the publisher.

Using the taxonomy or another related taxonomy may include using the taxonomy to identify, within the plurality of other documents stored within the same or a different memory, related contents associated with the categorized concepts, wherein the related contents belong to the same categories as the categorized concepts. Additionally, using the taxonomy or another related taxonomy also may include determining whether the taxonomy is related to another taxonomy and if it is determined that the taxonomy is related to another taxonomy, using the other related taxonomy to identify, within plurality of other documents within the same or a different memory, related contents associated with the categorized concepts. The related contents may belong to a category that is different but related to the category of the categorized concepts.

The method also may include identifying the other related taxonomy by referencing a table that lists taxonomies that are linked to one another, and thus identifying the other related taxonomy associated with the taxonomy of the extracted concepts. The related contents may belong to the same category as the categorized concepts. Alternatively or additionally, the related contents may belong to a category that is different but related to the category of the categorized concepts.

According to another general aspect, a method for identifying a taxonomy from among multiple taxonomies for categorizing an input phrase includes providing multiple taxonomies, each of the multiple taxonomies corresponding to a particular domain of knowledge, receiving an input phrase that is to be categorized by at least one of the multiple taxonomies, and tokenizing the received input phrase into one or more words. The method also includes selecting a first taxonomy from among the multiple taxonomies, identifying, for the selected first taxonomy, a stored weight associated with each of the one or more words, aggregating, for the selected first taxonomy, the stored weight associated with each of the one or more words to identify a first weight associated with the input phrase. The method also includes selecting a second taxonomy from among the multiple taxonomies, identifying, for the selected second taxonomy, a stored weight associated with each of the one or more words, and aggregating, for the selected second taxonomy, the stored weight associated with each of the one or more words to identify a second weight associated with the input phrase. The method also includes comparing the first and second weights associated with the input phrase to a threshold and based on a result of the comparison, routing the input phrase to the first or second taxonomy for categorization.

Implementations of the above general aspect may include one or more of the following features. For example, receiving the input phrase may include receiving a concept included in electronic content for which a supplemental and related electronic content is being identified. Tokenizing the input phrase may include dividing the input phrase into individual words.

Identifying, for the selected first and second taxonomies, the stored weight associated with each of the one or more words may include identifying the stored weight by referencing a table that includes a weigh associated with the one or more words. The table may include a row for each word in a lexicon, a column for each of the multiple taxonomies, and a score at the intersection of each row and column. The score at each intersection may indicate a likelihood that the input phrase including a word corresponding to each intersection may be classified by a particular taxonomy corresponding to the column of that intersection. Routing the input phrase may include routing the input phrase to the first and second taxonomies for categorization.

Implementations of the described techniques may include hardware, a method or process, or computer software on a computer-accessible medium.

The details of one or more implementations are set forth in the accompanying drawings and the description below. Other features will be apparent from the description and drawings, and from the claims.

### DESCRIPTION OF DRAWINGS

FIG. 1 is a block diagram of an exemplary networked computing environment.

FIG. 2 is a flow chart of a process for providing contextually valuable relevant content or advertisements related to published electronic content.

FIG. 3 is a flow chart of a process for identifying high value data related to electronic content.

FIG. 4 is a flow chart of a process for identifying concepts included in clusters of related electronic documents.

FIG. 5 is a flow chart of a process for identifying concepts included in an electronic document.

FIG. 6 is a block diagram of a concept categorizer including a router.

FIG. 7 is a block diagram of a table indicating the likelihood that a particular concept corresponds to a particular category of concepts.

FIG. 8 is a flow chart of a process for identifying likelihoods that a phrase corresponds to one or more taxonomies.

FIG. 9 is a flow chart of a process for training a router of a concept categorizer to route a concept to one or more relevant taxonomies for categorization.

FIG. 10 is a flow chart of a process for routing a phrase to one or more relevant taxonomies for categorization.

FIG. 11 illustrates an exemplary process used by a Sponsored Navigation application to crawl web pages associated with a publisher's web site and to extract and index the concepts appearing therein using one or more taxonomies.

FIG. 12 is a screen shot of a web page that has been supplemented with concept phrases that are hyperlinked to information on other pages within the publisher's website.

### DETAILED DESCRIPTION

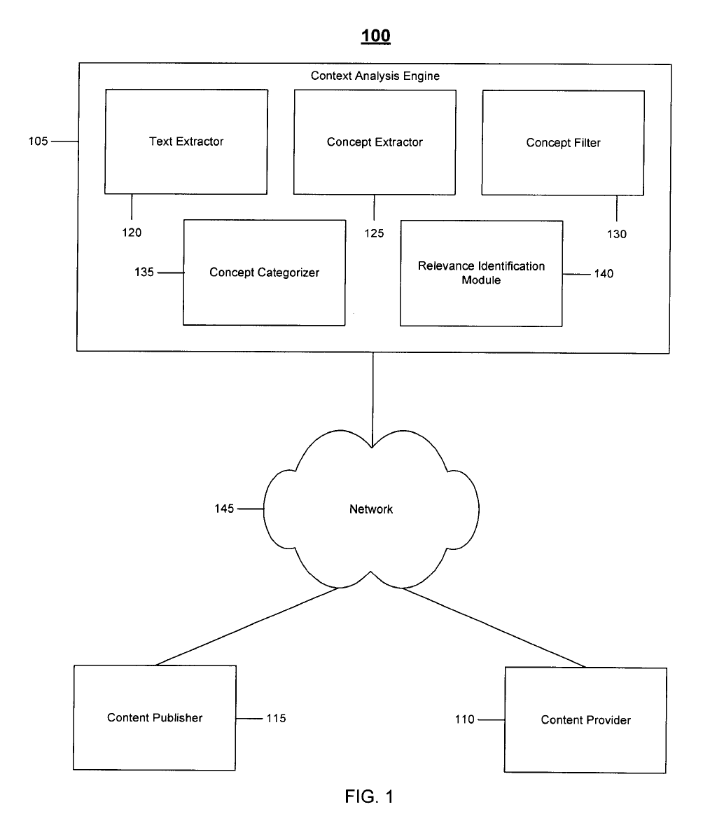

Referring to FIG. 1, a networked computing 100 environment enables the identification of high value data to be included in published electronic content. The networked computing environment includes an context analysis engine 105 that identifies relevant and/or related high value data provided by an content provider 110 for inclusion in content published by a content publisher 115. The context analysis engine 105 includes a text extractor 120, a concept extractor 125, a concept filter 130, a concept categorizer 135, and an relevance identification module 140. The context analysis engine 105, the content provider 110, and the content publisher 115 communicate using a network (e.g. the internet) 145.

The context analysis engine 105 identifies appropriate high value data to be included in content provided by the content publisher 115. The context analysis engine 105 processes the content to identify concepts included in the content and identifies supplemental content, such as contextually valuable relevant and/or related content or offers, to be included in the content. The context analysis engine 105 may request the supplemental content indirectly from an external source, such as the content provider 110 using concepts or categories of concepts included in the electronic content.

The content provider 110 provides supplemental content for inclusion in content provided by the content publisher 115. The content provider 110 may provide the content directly to the content publisher 115, or to the context analysis engine 105, which provides the supplemental content to the content publisher 110. The content provider 110 may provide the supplemental content in response to a request from the context analysis engine 105. As examples, the request may include one or more cost-per-click (CPC), a cost per impression (CPM), or a cost per action (CPA) terms and/or pieces of content. The CPM content may be text, or a graphical banner or semantically related content. A cost-per-click term is a term that has been auctioned to an entity such that supplemental content related to the entity is displayed in electronic content related to the cost-per-click term. The entity may pay the content provider 110 or the content publisher 115 each time an end-user viewing the displayed supplemental content actually clicks on the displayed supplemental content. In response to a request including a cost-per click term, the content provider 110 identifies and returns valuable or relevant content for an entity to which the cost-per-click term was auctioned. In a cost per impression model the entity pays for every thousand times their supplemental content is displayed to end-users. In a cost per action model the entity pays for every action, resulting from the supplemental content being displayed to the end-users. The features of the context analysis engine 105 may operate with advertising models other than CPC, CPM, or CPA.

The content publisher 115 is a publisher of electronic content in which supplemental content may be included. For example, the content publisher 115 may be a web server that provides web pages including space in which contextually valuable relevant and/or related content may be displayed. The content publisher 115 may sell the display space on the web pages such that relevant and/or related contextually valuable content may be included in the space. The content publisher 115 may place restrictions on the entities for which contextually valuable relevant and/or related content are included in the web pages. The content publisher 115 may receive the relevant and/or related contextually valuable content from the content provider 110 and may be contextually valuable in the electronic content.

In one implementation the context analysis engine 105 operates to analyze pieces of text (extracted from the content) and serves back content having perceived high “value”. The value may be based on a variety of valuation models including but not limited to CPC and CPM. The text extractor 120 extracts text from electronic content into which supplemental electronic content is to be included. For example, the text extractor 120 may receive a URL from which the electronic content may be accessed. The URL may be accessed from an RSS feed. In addition to accessing all of the text located at the URL identified in the RSS feed, the text extractor 120 may extract other text included in the RSS feed, such as a headline or other text describing the item located at the URL.

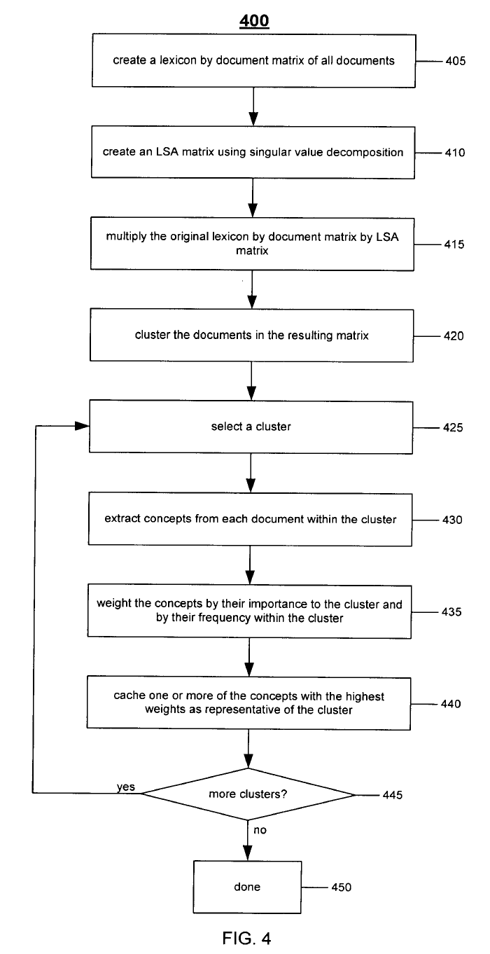

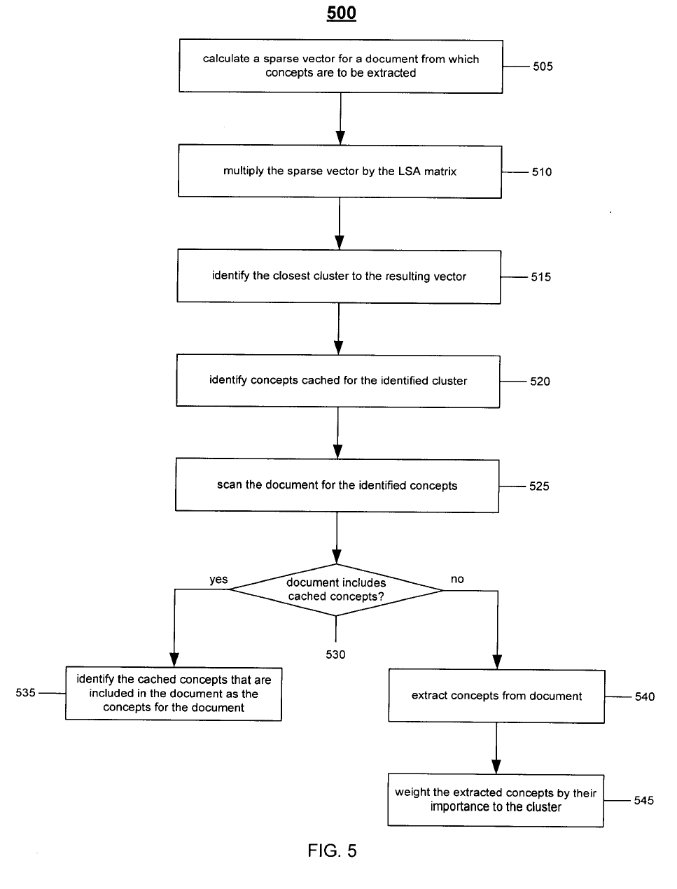

The concept extractor 125 extracts concepts from the text extracted by the text extractor 120. In one implementation, the concepts within the text are noun phrases appearing in the text. In such an implementation, each of the words included in the text may be tagged with a part of speech, and the parts of speech may be used to identify the noun phrases included in the text. Alternatively or additionally, proper nouns included in the text may be identified as concepts. A list of proper nouns may be used to recognize proper nouns from the text. The proper nouns may include names of people (e.g., celebrities, politicians, athletes, and authors), places (e.g., cities, states, countries, and regions), entities, companies, and products. A user may be enabled to modify the list of proper nouns to include only those proper nouns referring to entities in which the user is interested. In another implementation, Lexical Semantic Analysis (LSA) may be used to identify the concepts included in the extracted text. LSA is described in further detail with respect to FIGS. 4 and 5.

The concept extractor 125 also may weight the concepts extracted from the text, for example, using the TF.IDF weighting algorithm or another suitable weighting algorithm. The weight of a concept may depend on a frequency with which the concept appears in the text. Concepts that have low weights or that do not appear as frequently within the text as other concepts may be eliminated as contextually irrelevant.

The concept filter 130 filters the concepts identified by the concept extractor 125. In one implementation, the concept filter 130 may remove concepts that are not to be processed further, such as concepts relating to objectionable or unwanted subject matter, from the set of extracted concepts. For example, the concept filter 130 may filter concepts relating to adult content, gambling, or trademarked terms. The concept filter 130 also may highlight other concepts that are interesting or otherwise important.

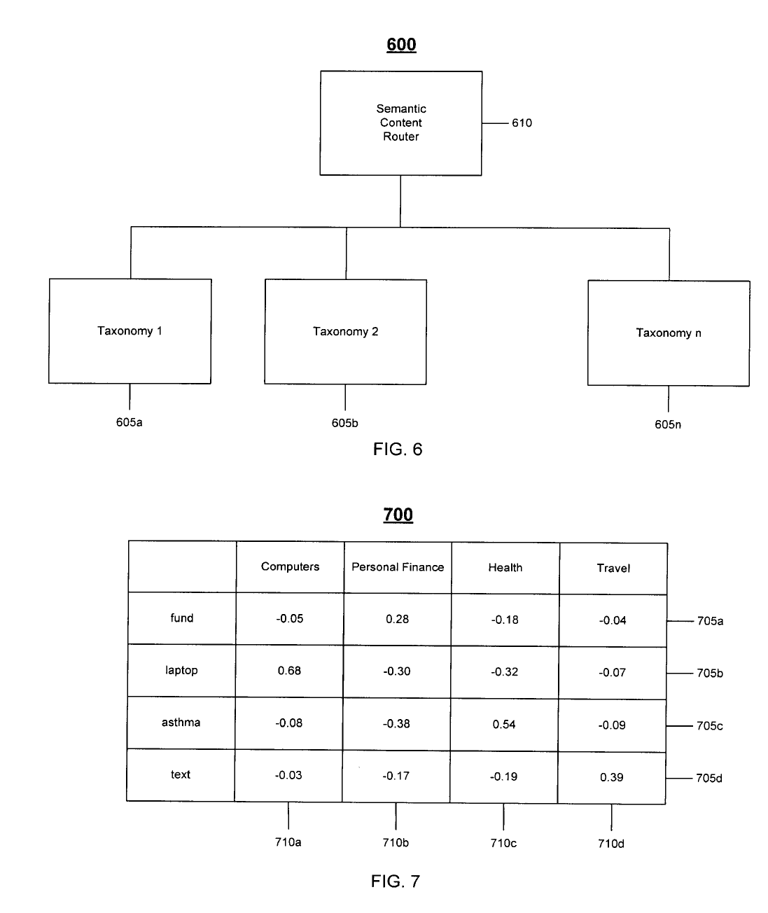

The concept categorizer 135 categorizes the extracted concepts that have not been filtered by the concept filter 130. The concept categorizer 135 may pass each of the extracted concepts to one or more taxonomies for categorization. The concept categorizer 135 is described in further detail with respect to FIGS. 6-10.

The relevance identification module 140 may identify one or more contextually valuable relevant and/or related content items to be included in the electronic content of the content publisher 110 based on the concepts and categories identified by the concept extractor 125 and concept categorizer 135. In one implementation, the relevance identification module 140 requests the contextually valuable relevant and/or related content from the content provider 110 by providing the content provider 110 with cost-per-click terms related to the identified categories. The cost-per-click terms identified by the relevance identification module 140 may be the cost-per-click terms for which the context analysis engine 105, the content provider 110, or the content publisher 115 receive the most revenue.

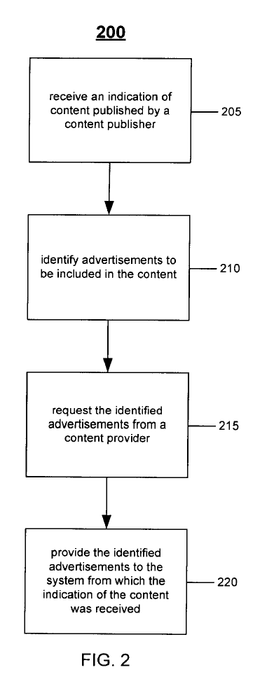

Referring to FIG. 2, a process 200 is used to identify one or more contextually valuable relevant and/or related content to be included in a piece of published electronic content to be displayed to an end user. The process 200 may be executed by a context analysis engine, such as the context analysis engine 105 of FIG. 1. The process 200 may be executed once as the content is published such that the contextually valuable relevant and/or related content may be included in the published content before the published content is accessed for presentation. Alternatively or additionally, the process 200 may be executed each time the published electronic content is presented to an end-user such that contextually valuable relevant and/or related content that are current at the time of presentation are included in the content.

The context analysis engine 105 receives an indication of content published by a content publisher, such as the content publisher 115 of FIG. 1 (step 205). The indication of the published content may be received from the content publisher, or from a computer system on which the published content is being displayed. The indication may include an indication of a URL from which the content may be accessed. In one implementation, the electronic content may be search results that are retrieved for a search query, and the indication of the electronic content may be the key words forming the search query. Alternatively or additionally, the indication of the electronic content may be the electronic content itself. The indication also may include one or more parameters describing valuable content that may be included in the content, such as a size of the content item or a type of content item (e.g., text only, graphical, flash based, video based) that may be included in the content.

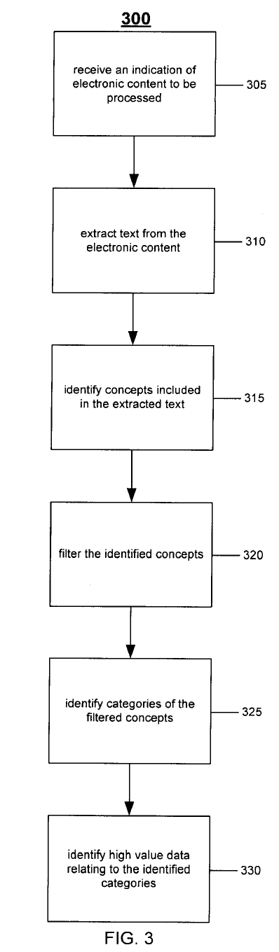

The context analysis engine 105 identifies contextually valuable relevant and/or related content to be included in the content (step 210). In one implementation, the context analysis engine 105 identifies an advertisement or a sponsored link corresponding to one or more cost-per-click terms that are relevant and/or related to the content. The manner in which the context analysis engine identifies the contextually valuable relevant and/or related content is described in further detail with respect to FIG. 3.

The context analysis engine 105 requests the identified contextually valuable relevant and/or related content from a content provider, such as the content provider 110 of FIG. 1 (step 215). For example, the context analysis engine 105 may provide the CPC terms to the content provider 110, and the content provider may provide contextually valuable relevant and/or related content relating to entities that purchased the CPC terms. The context analysis engine 105 receives the requested contextually valuable relevant and/or related content from the content provider 110 and provides the requested contextually valuable relevant and/or related content to the system from which the indication of the content was received (step 220). For example, if the indication of the content was received from the content publisher 115, the context analysis engine 105 may provide the contextually valuable relevant and/or related content to the content publisher 115. Alternatively or additionally, the content provider may provide 110 the contextually valuable relevant and/or related content directly to the system from which the indication of the content was received.

Referring to FIG. 3 a process 300 is used to identify contextually valuable relevant and/or related content or other supplemental content to be included in published electronic content. The process 300 may be executed by a context analysis engine, such as the context analysis engine 105 of FIG. 1. The process 300 may represent one implementation of step 210 of FIG. 2. The process 300 may be executed once at the same time the content is published such that the contextually valuable relevant and/or related content may be included in the published content before the published content is accessed for presentation. Alternatively or additionally, the process 300 may be executed each time the published electronic content is presented such that contextually valuable relevant and/or related content that are current at the time of presentation are included in the content.

The context analysis engine 105 receives an indication of content to be processed (step 305). For example, the context analysis engine 105 may receive a URL identifying electronic content that may include one or more contextually valuable relevant and/or related content. The URL may be included in an RSS feed. Alternatively or additionally, the indication of content may be an indication of a search query (e.g. the actual key words) for which search results are to be retrieved. Alternatively or additional, the indication of content may be an indication of an entry within a user generated web site, such as, for example, a Blog. The context analysis engine 105 extracts text from the electronic content (step 310). For example, the context analysis engine 105 may use a text extractor, such as the text extractor 120 of FIG. 1, to extract the text. Extracting the text may include accessing text located at the URL and other text describing the accessed text, such as other text included in the RSS feed. If the indication of the content is a search query, the text extractor may extract text from the search results for the search query, or simply may identify the key words forming the search query as the extracted text. If the indication of the content is an entry within the user generated web site (e.g., Blog), the text extractor may extract the entry within the Blog.

The context analysis engine 105 identifies the concepts included in the extracted text (step 315). More particularly, the context analysis engine may use a concept extractor, such as the concept extractor 125 of FIG. 1, to extract the text. The concept extractor 125 may identify noun phrases and proper nouns included in the extracted text as the concepts of the extracted text, as described above. Alternatively or additionally, the concept extractor may use LSA to identify the concepts, as will be described in further detail with respect to FIGS. 4 and 5. If the extracted text is one or more key words forming a search query, the entire search query may be identified as a single concept (or as multiple concepts depending on the key words) included in the extracted text.

The context analysis engine 105 filters the identified concepts (step 320). More particularly, the context analysis engine may use a concept filter, such as the concept filter 130 of FIG. 1, to filter the concepts. The concept filter 130 may remove concepts relating to objectionable or unwanted subject matter, for example, as defined by a publisher of the electronic content into which the contextually valuable relevant and/or related content will be inserted. The concept filter 130 also may highlight some of the concepts that are particularly relevant and/or related or important for the content.

The context analysis engine 105 identifies categories for the filtered concepts (step 325). For example, the context analysis engine may use a concept categorizer, such as the concept categorizer 135 of FIG. 1, to categorize the concepts. The concept categorizer 135 includes a semantic content router that operates to route each of the concepts to one or more domains of knowledge, represented by taxonomies or other representations included in the concept categorizer for categorization. The semantic content routing function within the router of the concept categorizer may identify which of the multiple domains of knowledge are used to categorize the concepts. The semantic content router also may simply determine an order in which the taxonomies should be used during the categorization process. The semantic content router also may be used to quickly guess to which domain a particular text belongs.

The context analysis engine 105 identifies high value or high relevancy data relating to the identified categories (step 330). More particularly, the context analysis engine 105 may use a relevance identification module, such as the relevance identification module 140 of FIG. 1, to identify the high value or high relevancy data. The high-value data may include one or more CPC terms for which corresponding contextually valuable relevant content or sponsored links may be requested, for example, from the content provider 110 of FIG. 1. Alternatively or additionally, the high value data may include the contextually valuable relevant and/or related content or sponsored links themselves.

For example, a search engine user may enter a series of key words that form the basis for an internet search query and submit the search query to the search engine by pressing or clicking enter. The search engine performs a search based on the key words and returns a web page of search results formatted as a listing of URLs or internet web page links that are likely relevant and/or related to the key words. The search engine also may forward the key words to the context analysis engine 105 which analyzes and identifies the key words as one or more concepts. The context analysis engine 105 then processes the concepts through one or more taxonomies as described herein and returns or otherwise generates a set of categorized concepts associated with the one or more taxonomies. The context analysis engine 105 then submits the categorized concepts to a database. The database may be located within the context analysis engine 105 or may be located remote from the context analysis engine 105, such as, for example, within the content provider 110. In either case, the database stores data that are indexed based on their categories.

The context analysis engine 105 requests, from the database, the related content associated with the categorized concepts, and, in response to the request, the context analysis engine 105 receives, from the database, the related content. In particular, in response to the request, a search module may identify a category of the categorized concepts and may use the category to identify, as the related content, content that appear within the database and that are associated with the identified category. The related content, in one example, include data having high relevancy and/or high value.

The related content may be displayed in a designated area of the search results web page. In particular, the related content may be displayed on the web page and may represent links to a new web page that will list a series of sponsored URLs or contextually valuable relevant and/or related content that are relevant and/or related to the concept phrases. Advertisers may pay to have their particular sponsored link or other suitable advertisement associated with those concept phrases displayed.

In one implementation, the context analysis engine 105 may identify multiple related content. Each of the multiple related content may have a value associated therewith. The value of the related content may appear in the database or another remote storage unit, and the value may be based on the price the content provider (e.g., advertiser) pays for each of the related content. Alternatively or additionally, the value of related content may be based on the revenue each of the related content is likely to generate or has generated in the past. The context analysis engine 105 uses this information to select from among the multiple related content or to rank the multiple related content. In one specific example, the context analysis engine 105 only displays the related content having the highest value associated therewith. In another example, the context analysis engine 105 displays only the two related blocks of content having the top two values. In yet another example, the context analysis engine 105 displays all the multiple related content and ranks them based on their value, such that the related content having the highest value is ranked first and the related contents having the lowest value is ranked last.

Referring to FIG. 4, a process 400 is used to identify sets of concepts commonly reflected in sets of related documents. The sets of concepts are identified by analyzing a large set of electronic documents using LSA, which is a type of least-squares algorithm that reduces the dimensionality of the training set in order to understand how concepts are related. This reduction clusters documents with similar semantic meanings close together in a high-dimensional space. The identified concepts for one of the sets of related documents may be used when identifying concepts included in a document that is related to the documents in the set. The process 400 may be executed by a concept extractor, such as the concept extractor 125 of FIG. 1, for example, when concepts of a document are to be identified.

The concept extractor 125 creates a lexicon by document matrix of all documents (step 405). The matrix may be created based on a large set of tagged news articles, such as the Reuters21578 text categorization test collection. The matrix includes a nonzero entry when a word corresponding to a row of the entry is included in a document corresponding to a column of the entry. In one implementation, the nonzero entry may represent the frequency with which the corresponding word appears in the corresponding document The concept extractor 125 creates an LSA matrix using singular value decomposition (SVD) (step 410). SVD is performed on the original matrix. SVD is optional and improves performance in terms of identifying more relevant and/or related concepts. SVD reduces the dimensionality of the space represented by the lexicon by document matrix to approximately 150. The concept extractor multiplies the original lexicon by document matrix by the LSA matrix (step 415), and clusters the documents in the resulting matrix (step 420). In one implementation, a standard clustering algorithm, such as the K-means algorithm, may be used to cluster the documents.

The concept extractor 125 selects one of the resulting clusters (step 425) and extracts concepts from each document within the cluster (step 430). In one implementation, extracting concepts from a document may include extracting noun phrases and proper nouns from the document, as described above. The concepts extracted from a document may be filtered to produce a reduced set of extracted concepts, as described above. The concept extractor weights the extracted concepts by their importance to the cluster and by their frequency within the cluster, for example, using the TF.IDF weighting algorithm (step 435). The concept extractor caches one or more of the concepts with the highest weights as representative of the cluster (step 440).

The concept extractor 125 determines whether concepts are to be extracted for more clusters of documents (step 445). If so, then the concept extractor selects a different cluster (step 425) and extracts (step 430), weights (step 435), and caches (step 440) concepts of documents included in the different cluster. After concepts are extracted and cached sequentially for each of the clusters, the process 400 is complete (step 450).

Referring to FIG. 5, a process 500 is used to identify concepts included in an electronic document. The identified concepts are concepts that are included in documents related to the electronic document. More particularly, LSA is used to identify a cluster of documents to which the electronic document is closest. The identified cluster may have an associated cache of concepts that may be used to better describe what the document is about. The process 500 is executed by a concept extractor, such as the concept extractor 125 of FIG. 1. Execution of the process 500 requires an earlier execution of the process 400 of FIG. 4.

The concept extractor 125 calculates a sparse vector for a document from which concepts are to be extracted (step 505). Each entry in the sparse vector corresponds to a word from a lexicon that may appear in the document. An entry in the sparse vector is nonzero when the document includes the word corresponding to the entry.

The concept extractor 125 multiplies the sparse vector by an LSA matrix, such as the LSA matrix created during the previous execution of process 400 of FIG. 4 (step 515). The resulting vector represents a position within the high-dimensional space represented by the LSA matrix. The concept extractor identifies the closest cluster to the resulting vector (step 515), and identifies the concepts cached for the identified cluster (step 520). The concept extractor scans the document for the identified concepts (step 525) and determines whether the document includes the identified concepts (step 530). If so, then the concept extractor identifies the cached concepts that are included in the document as the concepts of the document (step 535). Otherwise, the concept extractor extracts concepts from the document, for example, by identifying noun phrases and proper nouns from the document (step 540). The concept extractor also weights the extracted concepts by their importance to the cluster (step 545). In some implementations, the identified concepts may be cached as representative of the cluster. In other implementations both processes may be executed, namely identifying cached concepts and extracting new concepts.

In some implementations of the process 500, the document may be further analyzed to identify which concepts make the document most different from the other documents included in the identified cluster. For example, a concept from the document that is not included in the documents of the identified cluster may make the document most different from the documents of the identified cluster. Such a concept may be identified as a highly relevant concept of the document.

Referring to FIG. 6, a concept categorizer 600 is used to identify which of multiple taxonomies 605a-605n may be used to categorize a phrase. For example, the concept categorizer 600 may be used to identify which of the taxonomies 605a-605n may be used to categorize one of the concepts included in an electronic document for which additional related electronic content is being identified. The identified taxonomies may be taxonomies corresponding to a domain that relates to the phrase to be categorized. The concept categorizer 600 includes a semantic content router 610 that identifies the taxonomies 605a-605n to which a phrase to be categorized is routed. The concept categorizer 600 may be one implementation of the concept categorizer 135 of FIG. 1.

Each of the taxonomies 610a-610n is used to categorize a phrase provided to the taxonomy. Each of the taxonomies 610a-610n may correspond to a particular domain, and the taxonomy may classify the input phrase as representative of a category related to the particular domain. For example, the taxonomy 610a may correspond to a computer domain, in which case the taxonomy 610a may identify whether the input phrase identifies a type of computer, a type of computer component, or a type of computer software. However, the taxonomy 610a may not identify whether the input phrase identifies a hotel, since hotels are not related to the computer domain. Instead, another taxonomy, such as the taxonomy 610b, may relate to a travel domain such that the taxonomy 610b may determine whether the input phrase identifies a hotel.

Each of the taxonomies 610a-610n includes a hierarchy of categories relating to a corresponding domain. Each category is related to one or more hook rules. Each hook rule identifies one or more words that are included in typical phrases that are representative of a corresponding category. When an input phrase, or a portion thereof, matches a hook rule, then the input phrase is classified as being representative of a category to which the matched hook rule corresponds. A phrase may match a hook rule when all of the words of the hook rule are included in the input phrase, regardless of the order in which the words appear in the input phrase. For example, a taxonomy corresponding to personal finance may include a category for mutual funds. The mutual fund category may include a hook rule for each mutual fund that may be purchased. If the input phrase includes a name of a mutual fund, then the input phrase may be identified as corresponding to the mutual fund category, because the input phrase matches a hook rule of the mutual fund category (e.g., the hook rule identifying the name of the mutual fund).

The hierarchical structure of the categories in the taxonomy is a domain specific knowledge representation as well as a learning data set. In addition it is used to weight categories that helps in deciding the relevancy. More specifically, the hierarchy can provide more information for how to weight categories. For example, if several categories with the same parent latch to a document, the parent category should also be returned as a more general category.

In some implementations, a category may include negative hook rules. A negative hook rule identifies one or more words that are not included in typical phrases that are representative of the corresponding category. When an input phrase matches a negative hook rule for a category, the input phrase is not classified as belonging to the corresponding category. Thus, negative hook rules are also known as exclusion rules, are used to override hook rules in certain cases. For example, the exclusion “Barry Bonds” may be located in the “stocks and bonds” category to prevent the baseball player from latching to the finance related category.

In some implementations, an input phrase may be processed prior to matching against hook rules. For example, misspelled words within the input phrase may be corrected. Words of the input phrase may be replaced with their base or stem forms. For example, a noun may be put into its singular form, and a verb may be put into its infinitive form. In addition, words of the input phrase may be replaced according to one or more replacement rules. A replacement rule may identify a first word and a second word with which the first word is to be replaced when the first word appears in the input phrase. The first and second words may be synonyms, or may be otherwise interchangeable. Replacing words of the input phrase based on replacement rules reduces the number of hook rules required by the taxonomies 610a-610n. In one implementation, user confirmation may be required before the input phrase is modified.

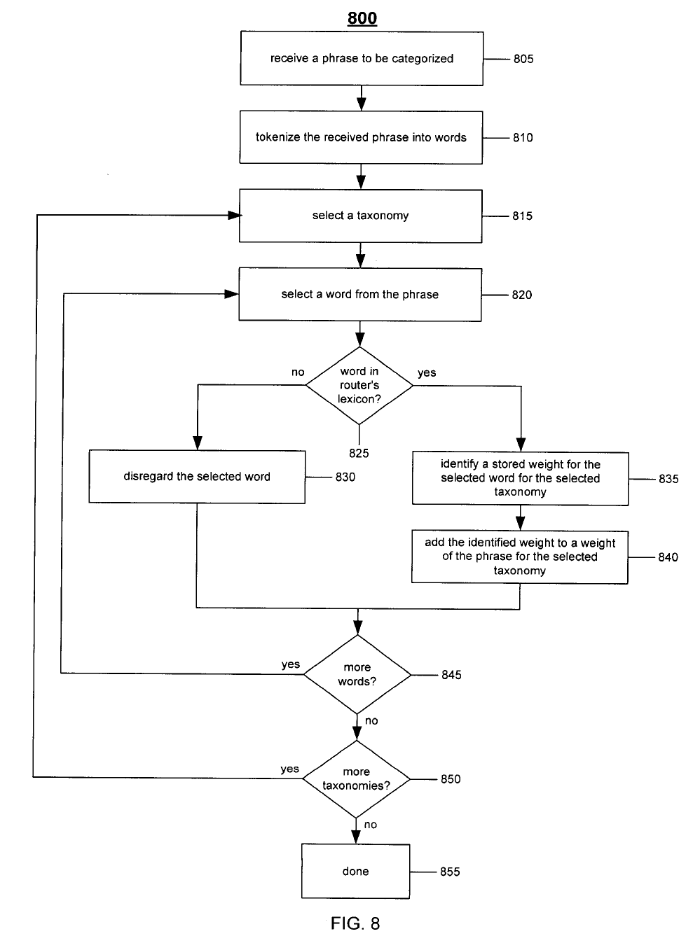

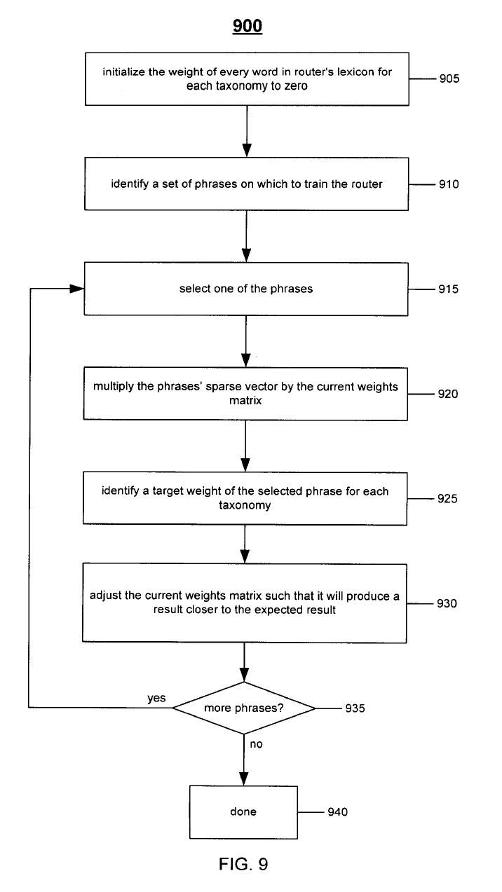

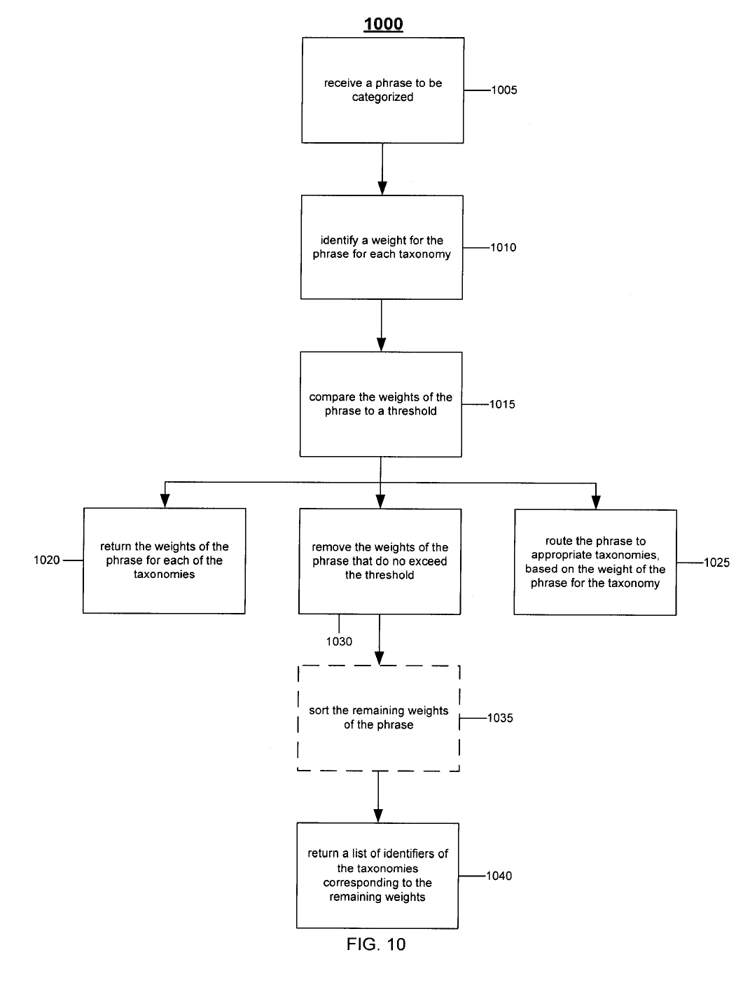

The semantic content router 610 identifies which of the taxonomies 610a-610n are appropriate for categorization of an input phrase according to a process that is discussed with respect to FIG. 10. In one implementation, the semantic content router 610 is a simple linear associator that uses the Widrow-Hoff error correction algorithm described with respect to FIG. 9 to learn to decide which taxonomy is most likely to properly handle an input phrase. The semantic content router 610 assigns a score to an input phrase for each of the taxonomies 610a-610n according to a process that is discussed with respect to FIG. 8. If the score of the input phrase for a particular taxonomy exceeds a threshold, then the particular taxonomy is identified as appropriate for the input phrase. The semantic content router 610 assigns the scores to an input phrase based on a table of scores that indicates the likelihood that each word of the input phrase is representative of a domain corresponding to each of the taxonomies 610a-610n.

Referring to FIG. 7, a table 700 is used by a semantic content router of a concept categorizer, such as the semantic content router 610 of FIG. 6, to assign scores to input phrases such that the input phrases may be routed to appropriate taxonomies for categorization. The table 700 includes a row for each word in a lexicon of the router, which includes the words that may appear in an input phrase. For example, the table 700 includes rows 705a-705d for the words “fund,” “laptop,” “asthma,” and “text,” respectively. In addition, the table includes a column for each taxonomy to which the input phrase may be routed for categorization. For example, the table includes columns 710a-710d for taxonomies corresponding to the computer, personal finance, health, and travel domains, respectively.

The score at the intersection of a particular row and a particular column indicates the likelihood that an input phrase including a word corresponding to a particular row may be classified by a taxonomy corresponding to the particular column. In other words, the score indicates the likelihood that typical content from the domain of the particular column includes the word of the particular row. A high score may indicate a high likelihood, and a low score may indicate a low likelihood. For example, the word “fund” has a high likelihood of corresponding to the personal finance domain and a relatively low likelihood of corresponding to the computer, health, or travel domains, as indicated by the row 705a.

Referring to FIG. 8, a semantic weighting process 800 is used to identify, for each of multiple taxonomies, a score indicating the likelihood that an input phrase is representative of a domain of phrases that may be categorized by the taxonomy. The score may be identified using a table identifying, for each word in the input phrase and for each of the multiple taxonomies, a weight indicating the likelihood that the word is included in an input phrase that may be correctly classified by the taxonomy. For example, the process 800 may be executed using the table 700 of FIG. 7. The process 800 may be executed by a router of a concept categorizer, such as the semantic content router 610 of FIG. 6, when scores for a phrase are to be identified for example, when identifying one or more of the taxonomies to which to the phrase should be routed, or when training the router to accurately identify the one or more taxonomies.

The router initially receives a phrase (step 805). The phrase may be a phrase that is to be categorized or a phrase on which the router is being trained. For example, the phrase may be a concept of an electronic document. The router tokenizes the received phrase into words (step 810). In one implementation, the router simply may tokenize the received phrase into individual words. In another implementation, the router may process the received phrase to identify whether any of the constituent words form an inseparable phrase. For example, if the input phrase is “buy personal computer,” the router may indicate that the input phrase has three components (e.g., “buy,” “personal,” and “computer”) or two components (e.g., “buy” and “personal computer”).

The router concurrently computes a single weight for the input phrase for each taxonomy. The computation of the single weight is based on a weighted sum of the weights for each word in the input phrase. For each taxonomy (step 815) and a word from the phrase (step 820), the router determines if the selected word is included in a lexicon of the router (step 825). In other words, the router determines whether a row in the table corresponds to the selected word. If not, then the router disregards the selected word (step 835), because the selected word cannot contribute to the score of the received phrase for the selected taxonomy. If the selected word is included in the table, then the router identifies a stored weight for the selected word for the selected taxonomy (step 835). For example, the router may identify an entry in the table at a row corresponding to the selected word and a column corresponding to the selected taxonomy. The router adds the identified weight to a weight of the phrase for the selected taxonomy (step 840).

The router determines whether the input phrase includes more words (step 845). If so, then the router selects a different word from the phrase (step 820) and determines whether the different word is in the router's lexicon (step 825). If not, then the word is disregarded (step 830). If so, then a stored weight of the different word is identified (step 835) and added to the weight of the phrase for the selected taxonomy (step 840). In this manner, the total weight of the phrase for the selected taxonomy is identified. After scores for the phrase have been identified for each of the taxonomies, the scores are compared to the threshold value defined. The document is then sent to all the taxonomies whose weighted score exceeds the threshold value. If the scores for none of the taxonomies exceed the threshold then the document is sent to the taxonomy with the highest weighted score. The process 800 is complete after this step. (step 855).

By way of example, the process 800 uses the table 700 of FIG. 7 to identify weights for the phrase “laptop text.” Such a phrase includes two words (“laptop” and “text”). For the computer taxonomy, the word “laptop” has a weight of 0.68, and the word “text” has a weight of −0.03, which gives the phrase a total weight of 0.65. For the personal finance taxonomy, the word “laptop” has a weight of −0.30, and the word “text” has a weight of −0.17, which gives the phrase a total weight of −0.47. For the health taxonomy, the word “laptop” has a weight of −0.32, and the word “text” has a weight of −0.19, which gives the phrase a total weight of −0.51. For the travel taxonomy, the word “laptop” has a weight of −0.07, and the word “text” has a weight of 0.39, which gives the phrase a total weight of 0.32. Consequently, the phrase “laptop text” has a high weight for the computer taxonomy and a relatively low weight for the other taxonomies.

In some implementations of the process 800, the semantic content router may consider not only the words that appear separately in an input phrase, but also how the words are distributed in the input phrase when identifying scores of the input phrase for each of the taxonomies. To do so, the semantic content router may include an additional, non-linear layer in its neural network. For example, a sigmoid function may be used after analyzing the words of the input phrase individually.

Referring to FIG. 9, a process 900 is used to train a router associated with a concept categorizer, such as semantic content the router 610 of FIG. 6, such that the router may accurately identify one or more taxonomies that may categorize an input phrase. In this learning phase, the router is presented with a series of tagged phrases that are representative of phrases corresponding to the taxonomies. The router identifies, for each of the phrases, scores indicating likelihoods of corresponding to a domain of each of the taxonomies. The router then modifies the scores to make the scores more clearly indicate that the electronic phrase corresponds to a particular one of the domains of the taxonomies. The process 900 may be executed when the router 610 and the concept categorizer 125 are initially deployed. Alternatively or additionally, the process 900 may be executed periodically on a recurring basis to update the router 610. The router's learning phase is enhanced through a process of providing additional words that are specific to a domain.

The router 610 initializes the weight of every word in a lexicon of the router to be zero for each possible taxonomy (step 905). For example, the router may construct a table, such as the table 700 of FIG. 7, in which all of the scores are zero. If the process 900 has been executed previously, then the router may not initialize the weights to be zero.

The router identifies a set of phrases on which the router will be trained (step 910). For example, the set of phrases may be provided by a user that is training the router. The set of phrases may be listed in a file or accessed from a database that is accessible to the router. The set of phrases may be identified from pieces of electronic content that are typical of the domains corresponding to the routers. The router selects one of the phrases (step 915), and multiplies the phrases' sparse vector by the current weights matrix (step 920). The router may identify the weight of the selected phrase for each taxonomy using the process 800 of FIG. 8.

The router identifies a target weight of the selected phrase for each taxonomy (step 925). The target weight may identify one of the taxonomies to which the selected phrase should correspond. The target weight for the selected phrase may be provided with the selected phrase itself. For example, the file or database from which the phrase was selected may include an indication of the target weight for the selected phrase. In one implementation, the target weight may be the same for all of the phrases in the set of phrases.

The router adjusts the current weights matrix such that it will produce a result closer to the expected result (step 930). In other words, the router may add or subtract a predetermined amount from each of the stored weights based on whether the stored weights correctly contribute to indicating that the selected phrase should be routed to the taxonomy indicated by the target weight. For example, the router may add the predetermined amount to the weights stored for one or more of the words included in the selected phrase for the taxonomy indicated by the target weight. In addition, the router may subtract the predetermined amount from the weights stored for one or more of the words of the selected phrase for each of the other taxonomies. The router may adjust the stored weights in order to move the identified weight closer to the target weight.

The router determines whether the router is to be trained on more phrases from the set of phrases (step 935). If so, then the router selects a different phrase (step 915), performs multiplication of the phrases' sparse vector by the current weight matrix (step 920) and identifies a target weight (step 925) of the different phrase for each of the taxonomies, and adjusts the current weights matrix such that it will produce a result closer to the expected result (step 930). In this manner, the router is trained on each of the phrases in the set of phrases until the router has been trained on all of the phrases from the set of phrases, in which case the process 900 is complete (step 940).

On each iteration of the steps 915-940, one or more entries of the table are adjusted such that at least some of the entries in the table have nonzero values. After training on a sufficiently large number of phrases that are equally representative of the different domains corresponding to the taxonomies, the weights within the table settle on values that accurately identify domains of electronic content that includes the corresponding words.

Referring to FIG. 10, a process 1000 is used to route a phrase to appropriate taxonomies for categorization. The appropriate taxonomies are identified as taxonomies corresponding to domains that are likely to represent the phrase. The process 1000 is executed by a router of a concept categorizer, such as the semantic content router 610 of FIG. 6.

The router receives a phrase to be categorized (step 1005). The phrase may be received as the router is being trained, or as high value data related to electronic content that includes the phrase is being identified, such as for example as an output of the semantic weighting process 800 (e.g. from step 855). The router identifies a weight of the phrase for each of multiple available taxonomies (step 1010). The weights of the phrase for the taxonomies may be identified using the process 800 of FIG. 8.

The router compares the weights of the phrase for the taxonomies to a threshold (step 1015). The threshold may be configured by a user. Before comparing the weights to the threshold, the weights may be normalized. For example, the highest weight may be set to 1.0, and the other weights may be scaled accordingly.

The router then may return the weights of the phrase for the taxonomies to an external application (step 1020). The external application may use the returned weights to identify which of the taxonomies should be used to categorize the phrase, or for another purpose unrelated to categorizing the phrase. In some implementations, the weights may be returned to the external application without first being normalized or compared to the threshold.

In another implementation, the router removes the weights of the phrase that do not exceed the threshold (step 1030). Consequently, the taxonomies corresponding to the removed weights will not be used to categorize the phrase. The router may sort the remaining weights, for example, such that the largest weight appears first (step 1035). The router then returns a list of identifiers of taxonomies corresponding to the remaining weights to the external application (step 1040). As a result, the external application is not provided with an indication of the weights, but rather of the taxonomies that should be used to categorize the phrase. The external application may submit the phrase to the indicated taxonomies for categorization. In implementations in which the weights are sorted, the first indicated taxonomy may represent the taxonomy for which the phrase had the highest score, which may be the taxonomy that has the greatest likelihood of correctly classifying the phrase.

The context analysis engine 105 can be used to implement valuable monetization and navigation applications on web sites. The monetization application, in one example, may include a ClickSense™ application. In one example, the ClickSense™ application displays advertisement on web pages that are highly relevant to the content of the web pages or to the content of the search query used to obtain the web pages. To illustrate, the ClickSense™ application analyzes the search query, URL (e.g., Webpage), RSS feed, blog, or any block of text, and using the semantic content router and available advertising inventory, the ClickSense™ application locates contents (e.g., advertisements) that are related and/or relevant to the search query, URL, RSS feed, blog, or block of text, and serves these contents (e.g., advertisements) onto the page the internet user has requested.

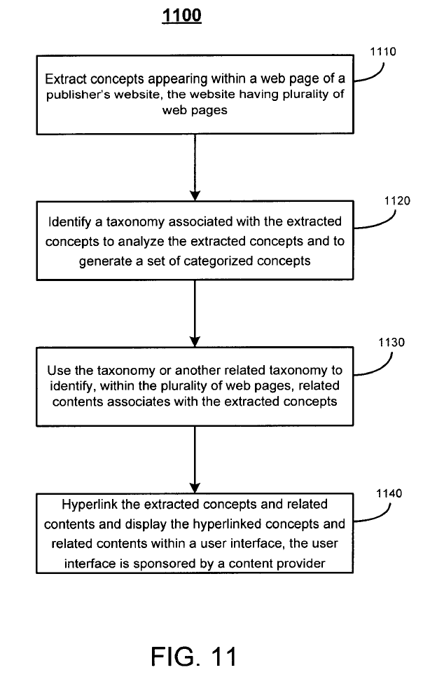

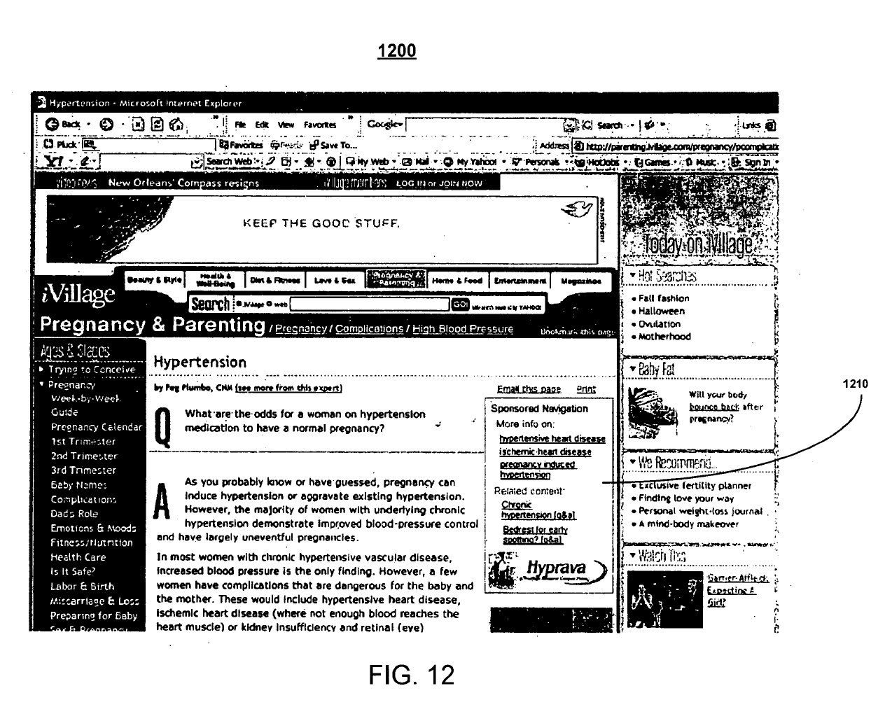

Another example of a monetization and navigation applications that may be implemented using the context analysis engine 105 is a Sponsored Navigation application. The Sponsored Navigation application uses the context analysis engine 105 to crawl or otherwise search the documents (e.g., web pages) associated with the publisher's web site and to extract and categorize concepts appearing therein using one or more taxonomies. To this end, the Sponsored Navigation application identifies a taxonomy associated with the extracted concepts and uses the taxonomy to analyze the extracted concepts and to generate a set of categorized concepts. The categorized concepts are then used in conjunction with the taxonomy or another related taxonomy to identify related content associated with the extracted concepts. Upon identifying related content for the extracted concepts, the Sponsored Navigation application hyperlinks the extracted concepts and related content (identified using the taxonomy) and displays the hyperlinks in the form of an advertising unit within the web pages. The advertising unit can be sponsored by an advertiser, and hence the name “Sponsored Navigation.” Clicking on any of these hyperlinks within the advertising unit takes the user to the web page having additional “content” about the concept. The above described process is described below in more detail with respect to FIG. 11 and later illustrated in an example shown in FIG. 12.

FIG. 11 illustrates an exemplary process 1100 used by the Sponsored Navigation application to crawl web pages associated with the publisher's web site and to extract and categorize the concepts appearing therein using one or more taxonomies. Using various software modules within the context analysis engine 105, process 1100 begins with extracting concepts within a web page associated with the publisher's web site (step 1110). In one example, extracting concepts includes extracting text associated with the web page and extracting noun phrases appearing within the text. Alternatively or additionally, extracting concepts may include extracting text associated with the web page and extracting proper nouns appearing within the text. A list of proper nouns may be used to recognize proper nouns from the text. The proper nouns may include names of people (e.g., celebrities, politicians, athletes, and authors), places (e.g., cities, states, countries, and regions), entities, companies, and products. A user may modify the list of proper nouns to include only those proper nouns referring to entities in which the user is interested. In another implementation, LSA may be used to identify the concepts included in the extracted text. This implementation was described in detail above with respect to FIGS. 4 and 5, and therefore is not further described here.

After extracting concepts from the web page, the Sponsored Navigation application identifies at least one taxonomy to analyze the extracted concepts and to generate a set of categorized concepts (step 1120). The taxonomy may correspond to a domain related to the extracted concepts. In one implementation, the Sponsored Navigation application may use processes, such as, for example, processes 800, 900, and 1000, which were described in detail above with respect to FIGS. 8-10, and therefore are not further described here, to identify the taxonomy that is related to the extracted concepts.

The Sponsored Navigation application uses the taxonomy to generate a set of categorized concepts. The categorized concepts, in one example, may include extracted concepts that are specifically associated with one or more categories or channels, such as for example, sports, mutual funds, and/or computer categories. After generating the set of categorized concepts, the Sponsored Navigation application uses the taxonomy to identify other related content and/or relevant data that are associated with the extracted concepts and that appear within the other web pages of the publisher's web site (step 1130). Alternatively or additionally, the Sponsored Navigation application uses the taxonomy to identify related content and/or relevant data appearing within web pages of another web site.

To identify the related content, in one implementation, the Sponsored Navigation application references a database. The database may be located within the context analysis engine 105 or may be located remote from the context analysis engine 105, such as, for example, within the content provider 110. In either case, the database stores data that are indexed based on their categories. The data may include related content that appear within the web pages of the publisher's web site or another web site and that are associated with the extracted concepts. The related contents are categorized using the taxonomy.

The Sponsored Navigation application accesses the database and identifies related content that share the same category as the categorized concepts. Alternatively or additionally, the Sponsored Navigation application may identify contents having categories similar or related to the category associated with the categorized concepts. In one example, the Sponsored Navigation application may reference a table that links one or more categories to one or more other categories (e.g., health category to sport category) to determine whether other content belonging to other categories should be identified as related content for the categorized content. If so, the Sponsored Navigation application identifies that content within the database and displays that content on the web page. To illustrate, in one specific example, where the categorized concepts belong to health category, the Sponsored Navigation application accesses the database to identify the related content belonging to health category. Alternatively or additionally, the Sponsored Navigation application may reference the table and realize that health category is linked to sports category (or another category different from the health category). In this scenario, the Sponsored Navigation application identifies, within the database, related content belonging to the sports category.

In another implementation, instead of accessing a database that has previously stored the related content associated with the web pages of the publishers web site or another web site, the Sponsored Navigation application may use the taxonomies to directly search web pages of the publisher's web site or web pages of another web site and to identify content sharing same or similar categories as the categorized contents. In either case, the Sponsored Navigation application hyperlinks the extracted concepts and the related content and displays this information in a form of an advertising unit within the web page of the publisher's web site (step 1140). The advertising unit may be sponsored by an advertiser (e.g., “Sponsored Navigation”). In a slightly different scenario, the Sponsored Navigation application may display the advertising unit within the web page of other content providers, who may have contractual relationship with the publisher.

Selecting (e.g., “clicking on”) any of these hyperlinks within the advertising unit “trigger” multiple ad delivery options, such as “transition ad,” an “in-line” text ad or a graphical ad about the topic. After transitioning, the user can explore the ad or be taken to the section of the web page where additional “content” about the concept is presented.

FIG. 12 illustrates a screen shot of a web page 1200 that has been supplemented with the advertising unit sponsored by Hyprave™. The advertising unit includes concept phrases that are hyperlinked to related content appearing on other web pages of the publisher's web site. In particular, the publisher's web site is crawled and concepts are extracted and categorized using fine grained taxonomy. For example, as shown, concepts like “hypertensive heart disease” that appear on the web page 1200 and other related content like “ischemic heart disease” appearing, for example, on the same web page or another web page of publisher's website are identified, hyperlinked, and displayed in the sponsored advertising unit 1210 using process 1100. As such, the viewer of the web page 1200 can easily view other related content associated with “hypertensive heart disease” and appearing within other web pages of the publisher's website.

Other implementations are within the scope of the following claims. For example, although the Sponsored Navigation application is described above as crawling web pages associated with a publisher's web site to extract and index all concepts appearing therein, the Sponsored Navigation application can easily perform the same operations on other documents appearing in other databases.

What is claimed is:

1. A method for supplementing an input content with related content, the method comprising:
receiving an input content for which related content is to be identified;
extracting text associated with the input content;
identifying concepts within the extracted text;
identifying at least one taxonomy associated with the concepts;
analyzing the concepts using the at least one taxonomy to generate a set of categorized concepts associated with one or more categories of the at least one taxonomy;
submitting the categorized concepts to a database, wherein the database stores data that are indexed based on their categories;
requesting, from the database, the related content associated with the categorized concepts;
receiving, from the database, the related content in response to the request;
supplementing the input content with the related content; and
enabling a user to view the related content.

2. The method of claim 1 wherein the input content includes a search query for which search results are to be retrieved.

3. The method of claim 2 wherein extracting the text associated with the input content includes extracting keywords comprising the search query.

4. The method of claim 2 wherein extracting the text associated with the input content further includes:
accessing the search results; and
extracting the text from the accessed search results.

5. The method of claim 1 wherein:
receiving the input content includes receiving a uniform resource locator; and
extracting the text associated with the input content includes:
accessing a web page located at the uniform resource locator; and
extracting text associated with the web page.

6. The method of claim 1 wherein:
receiving the input content includes receiving an RSS feed; and
extracting the text associated with the input content includes extracting the text included in the RSS feed.

7. The method of claim 1 wherein:
receiving the input content includes receiving an entry within a Blog; and
extracting the text associated with the input content includes extracting the entry within the Blog.

8. The method of claim 1 wherein the related content includes an advertisement or sponsored link corresponding to one or more cost-per-click, cost-per-impression, or cost-per-action terms that are relevant or related to the input content.

9. The method of claim 1 wherein identifying the concepts within the extracted text includes identifying one of noun phrases or proper nouns included in the text.

10. The method of claim 1 wherein receiving the related content further includes:
identifying a category of the categorized concept; and
identifying, as the related content, content that appear within the database and that are associated with the identified category.

11. A system for supplementing an input content with related content, the system comprising:
a context analysis processing device; and
a storage device storing instructions for causing the context analysis processing device to:
receive an input content for which related content is to be identified;
extract text associated with the input content; identify concepts within the extracted text;
identify at least one taxonomy associated with the concepts;
analyze the concepts using the at least one taxonomy to generate a set of categorized concepts associated with one or more categories of the at least one taxonomy;
submit the categorized concepts to a database, wherein the database stores data that are indexed based on their categories;
request, from the database, the related content associated with the categorized concepts;
receive, from the database, the related content in response to the request;
supplement the input content with the related content; and
enable a user to view the related content.

12. The system of claim 11 wherein the input content includes a search query for which search results are to be retrieved.

13. The system of claim 12 wherein, to extract the text associated with the input content, the instructions include instructions for extracting keywords comprising the search query.

14. The system of claim 12 wherein, to extract the text associated with the input content, the instructions further include instructions for:
accessing the search results; and
extracting the text from the accessed search results.

15. The system of claim 11 wherein:
to receive the input content, the instructions include instructions for receiving a uniform resource locator; and
to extract the text associated with the input content, the instructions include instructions for:
accessing a web page located at the uniform resource locator; and
extracting text associated with the web page.

16. The system of claim 11 wherein:
to receive the input content, the instructions include instructions for receiving an RSS feed; and to extract the text associated with the input content, the instructions include instructions for extracting the text included in the RSS feed.

17. The system of claim 11 wherein:
to receive the input content, the instructions include instructions for receiving an entry within a Blog; and
to extract the text associated with the input content, the instructions include instructions for extracting the entry within the Blog.

18. The system of claim 11 wherein the related content includes an advertisement or sponsored link corresponding to one or more cost-per-click, cost-per-impression, or cost-per-action terms that are relevant or related to the input content.

19. The system of claim 11 wherein to identify the concepts within the extracted text, the instructions include instructions for identifying one of noun phrases or proper nouns included in the text.

20. The system of claim 11 wherein to receive the related content, the instructions further include instructions for:
identifying a category of the categorized concept; and identifying, as the related content, content that appear within the database and that are associated with the identified category.
